(19) United States
(12) Patent Application Publication
(10) Pub. No.: US 2013/0258577 A1
(43) Pub. Date: Oct. 3, 2013

(54) EMBEDDED MEMORY MODULE AND MAIN BOARD INSERTEDLY PROVIDED THEREFOR

(71) Applicant: INNODISK CORPORATION, NEW TAIPEI CITY (TW)

(72) Inventors: HSI-HSI WU, NEW TAIPEI CITY (TW); CHIN-CHUNG KUO, NEW TAIPEI CITY (TW)

(73) Assignee: INNODISK CORPORATION, NEW TAIPEI CITY (TW)

(21) Appl. No.: 13/853,198

(22) Filed: Mar. 29, 2013

(30) Foreign Application Priority Data
Mar. 29, 2012 (TW) 101111038

(51) Int. Cl. G06F 1/16

(52) U.S. Cl. CPC G06F 1/16
USPC 361/679.32

(57) ABSTRACT

The present invention provides an embedded memory module and a main board insertedly provided therefor, the embedded memory module comprises at least one flash memory and a controller that are installed on a circuit board with a signal transmitting connecting plug. The embedded memory module is inserted into a connecting seat of the main board by the signal transmitting connecting plug so as to transmit at least one data conforming to eMMC transfer protocol specification. Wherein the controller and the flash memories are installed on the circuit board instead of being packaged in a conventional BGA form, and the embedded memory module and the main board are connected together by a way of insertion. Thus, not only the yield rate and effect of heat dissipation of the embedded memory module may be enhanced, but also the memory capacity of the main board may be expanded readily.

### CROSS-REFERENCES TO RELATED APPLICATIONS

This application claims the benefit of Taiwan, R.O.C. Patent Application No. 101111038 filed on Mar. 29 2012, the disclosures of which is incorporated by reference herein in their entirety.

### FIELD OF THE INVENTION

The present invention is related to an embedded memory module and main board insertedly provided therefor, particularly to a memory module, having a signal transmitting connecting plug capable of transmitting data conforming to eMMC transfer protocol specification, and a main board insertedly provided therefor.

### BACKGROUND

eMMC (embedded Multi Media Card) is a standard specification for an embedded memory established by MMC association, generally applied to portable electronic devices (such as, mobile phones, tablet computers, for example).

Referring to FIGS. 1 and 2, there are shown a construction diagram from bottom view of a conventional embedded memory chip and a cross-section construction diagram of the conventional embedded memory chip provided on a main board. As illustrated in these figures, a conventional embedded memory chip 100 is a memory chip conforming to eMMC standard specification, which is packaged in a way of BGA (Ball Grid Array), where a controller 11 and at least one flash memory 13 are stackingly provided on a substrate 17, below which a plurality of ball structures 10 (such as 169 ball structures, for example) are included, and the controller 11 and the flash memories 13 are electrically connected to a lead frame 171 of the substrate 17 through leads 15.

Furthermore, the embedded memory chip 100 is joined to the layout circuit of a main board 200 within an electronic device by means of the ball structures 10, in such a way that a microprocessor 21 of a main board 200 is allowed to access the embedded memory module 100 with respect to at least one data conforming to eMMC transfer protocol specification through the ball structures 10.

The conventional embedded memory chip 100 is packaged in a way of BGA, where the controller 11 and the flash memories 13 are stackingly formed as a chip structure, in such a way that the embedded memory chip 100 may be reduced in volume significantly, and welded onto the main board 200 of the electronic device quickly so as to shorten manufacturing cycle time of the electronic device. However, some problems occur when the embedded memory chip 100 is fabricated in a way of BGA package as follows:

1. It is impossible to construct more flash memories 13 in view of the size of the package of the embedded memory chip 100, thus restricting the memory capacity provided by the embedded memory chip 100.

2. It is liable to cause the problem in heat dissipation due to the fact that the controller 11, the flash memory 13 and power supply circuit are packaged in a way of stack in a small chip.

3. It is hard to enhance the yield rate when the embedded memory chip 100 is fabricated in a way of BGA package. Furthermore, the whole embedded memory chip 100 should be classified into the defective product incapable of being repaired, only if one element (such as the controller 11 or flash memory 13, for example) of the embedded memory chip 100 is failed or faulty during manufacturing process of the chip.

4. The embedded memory chip 100 on the main board 200 is incapable of being replaced by a user himself, and should be returned to the factory to be replaced with new one, due to the fact that the embedded memory chip 100 is welded onto the main board 200 through the ball structures 10.

As such, the present invention provides an embedded memory module having a novel structure. To solve the problem occurred due to the conventional embedded memory chip so as to provide an embedded memory chip having a high yield rate, better heat dissipation and more memory capacity is then the object of the present invention.

### SUMMARY OF THE INVENTION

It is one object of the present invention to provide an embedded memory module, in which a controller and flash memories are installed on a circuit board, the controller and the flash memories being then fabricated on the circuit board instead of being packaged in the former ball grid array (BGA) form, in such a way that easy inspection and maintenance with respect to the elements may be obtained, further enhancing the yield rate of the embedded memory module effectively.

It is one object of the present invention to provide an embedded memory module, in which the controller, flash memories and power supply circuit are installed on the circuit board individually, in such a way that not only more flash memories may be constructed so as to enhance memory capacity, but also better effect of heat dissipation may be obtained.

It is one object of the present invention to provide an embedded memory module, in which easy replacement of one failed or damaged element may be also achieved, due to the fact that the controller, flash memories and power supply circuit are installed on the circuit board independently.

It is one object of the present invention to provide an embedded memory module and main board insertedly provided therefore, in which the embedded memory module is inserted into a signal transmitting connecting seat of the main board by means of a signal transmitting connecting plug. Thus, a user is allowed to replace the embedded memory module inserted into the main board by himself, so as to enhance the convenience in memory repair or expansion.

It is one object of the present invention to provide an embedded memory module and main board insertedly provided therefore, in which the embedded memory module being inserted into a signal transmitting connecting seat of the main board by means of a signal transmitting connecting plug, so that the main board is allowed to access the embedded memory module with respect to at least one data conforming to eMMC transfer protocol specification through the inserted connection between the signal transmitting connecting plug and the signal transmitting connecting seat.

To achieve above objects, the present invention provides an embedded memory module, comprising: a circuit board, comprising a signal transmitting connecting plug; at least one flash memory, used for storing data; and a controller, the controller and the flash memories being installed on the circuit board, the controller being connected to the flash memories and the signal transmitting connecting plug, the embedded memory module transmitting at least one data conforming to eMMC (embedded Multi Media Card) transfer protocol specification by means of the signal transmitting connecting plug.

In one embodiment of the present invention, wherein the signal transmitting connecting plug is a connecting plug conforming to SD interface standard specification, a connecting plug conforming to CF interface standard specification, a connecting plug conforming to Cfast interface standard specification, a connecting plug conforming to MS interface standard specification, a connecting plug conforming to MMC interface standard specification, a connecting plug conforming to SATA interface standard specification, a connecting plug conforming to IDE interface standard specification, a connecting plug conforming to USB interface standard specification, a connecting plug conforming to PCI-E interface standard specification, other signal transmitting connecting plugs conforming to interface standard specifications used for transmitting data, a gold finger signal transmitting connecting plug conforming to self-established specification or a pin type signal transmitting connecting plug conforming to self-established specification.

In one embodiment of the present invention, wherein the signal transmitting connecting plug is formed as a gold finger interface connecting plug or a pin type interface connecting plug.

In one embodiment of the present invention, wherein the controller and the flash memories are installed on the circuit board independently.

In one embodiment of the present invention, wherein the controller and the flash memories are packaged as a ball grid array chip, so as to be joined to the circuit board by means of ball structures.

The present invention further provides a main board, insertedly provided for the embedded memory module, comprising: a micro-processor; and at least one signal transmitting connecting seat, connected to the micro-processor; wherein the embedded memory module is inserted into the connecting seat of the main board by means of the signal transmitting connecting plug, in such a way that the micro-processor of the main board is allowed to access the embedded memory module with respect to at least one data conforming to eMMC transfer protocol specification.

### BRIEF DESCRIPTION OF DRAWINGS

FIG. 1 is a construction diagram from bottom view of a conventional embedded memory chip.

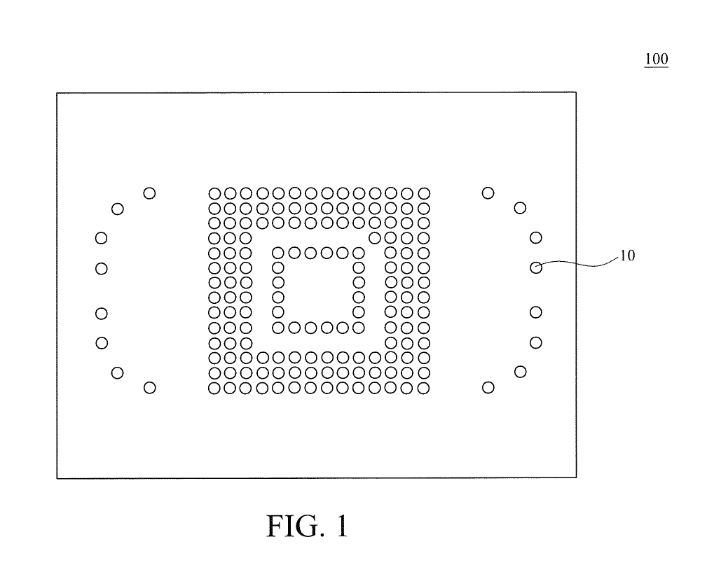

FIG. 2 is a cross-section construction diagram of the conventional embedded memory chip provided on a main board.

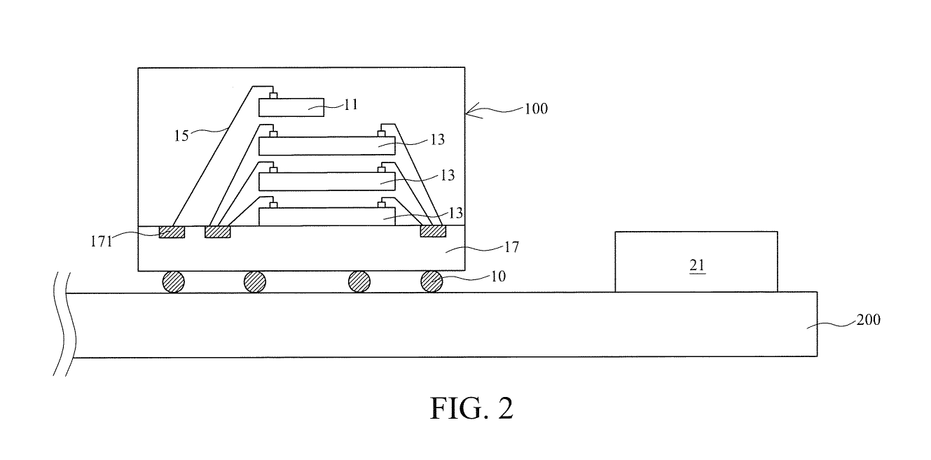

FIG. 3 is a circuit structure diagram of an embedded memory module and a main board insertedly provided therefor according to one preferred embodiment of the present invention.

FIG. 4 is a stereoscopic construction diagram of the embedded memory module and the main board insertedly provided therefor according to one preferred embodiment of the present invention.

FIG. 5 is a cross-section construction diagram of an embedded memory module according to one embodiment of the present invention.

FIG. 6 is a circuit structure diagram of the embedded memory module and a main board insertedly provided therefor according to one embodiment of the present invention.

FIG. 7 is a stereoscopic construction diagram of the embedded memory module and the main board insertedly provided therefor according to one embodiment of the present invention.

FIG. 8 is a stereoscopic construction diagram of the embedded memory module and the main board insertedly provided therefor according to one embodiment of the present invention.

### DETAILED DESCRIPTION

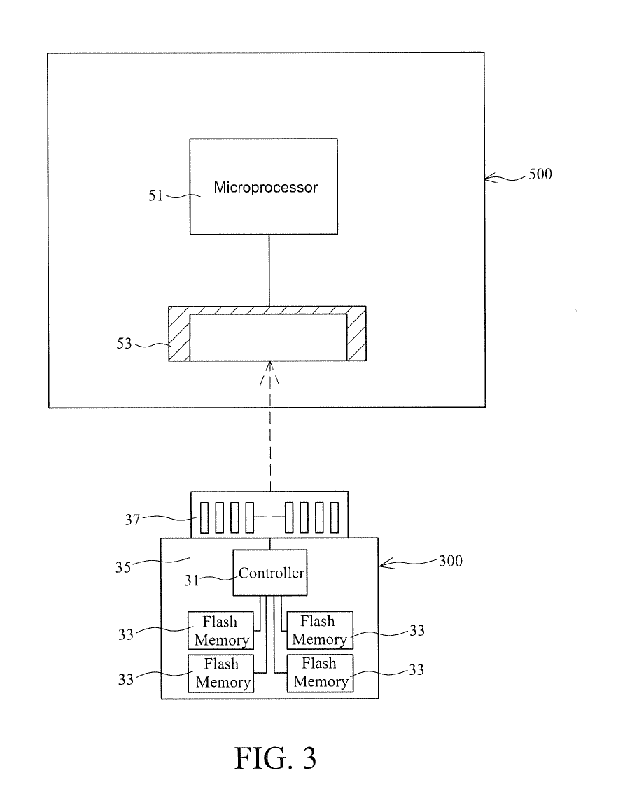

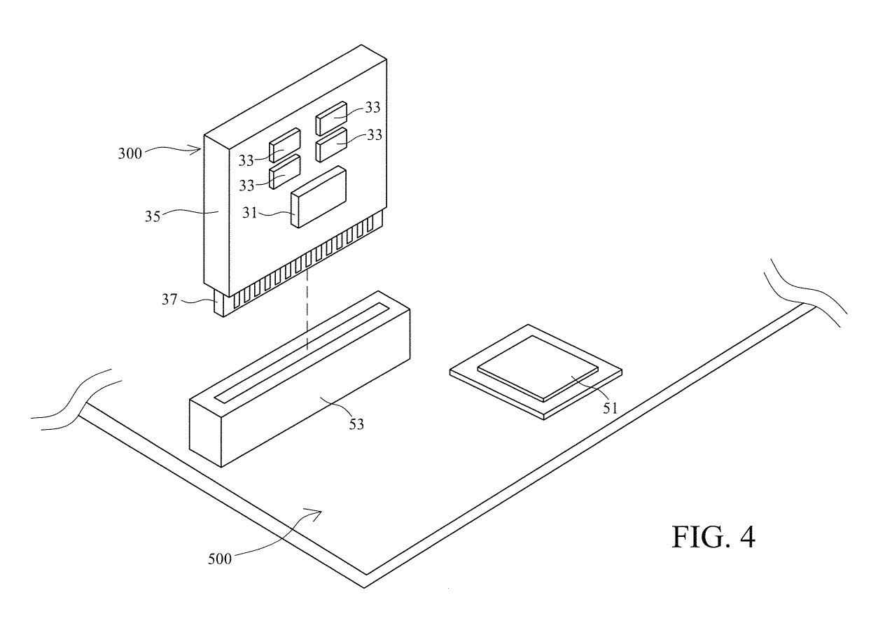

Referring to FIGS. 3 and 4, there are shown a circuit structure diagram and a stereoscopic construction diagram of an embedded memory module and a main board insertedly provided therefor according to one preferred embodiment of the present invention, respectively. As illustrated in these figures, an embedded memory module 300 of the embodiment comprises a controller 31, at least one flash memory 33 and a circuit board 35. The embedded memory module 300 may be inserted into a main board 500. The main board 500 comprises a microprocessor 51 and a signal transmitting connecting seat 53, the microprocessor 51 is electrically connected to the signal transmitting connecting seat 53. Besides, the main board 500 is a main board for electronic device (such as, computer, mobile phone and portable electronic product, for example).

In this case, the controller 31, flash memories 33 and power supply circuit are installed on the circuit board 35 independently. On one side of the board body of the circuit board 35, there is provided with a signal transmitting connecting plug 37. Moreover, the controller 31 is electrically connected to the flash memories 33 and the signal transmitting connecting plug 37, respectively.

Furthermore, the signal transmitting connecting plug 37 mentioned in the present invention is a connecting plug conforming to SD (Secure Digital Memory Card) interface standard specification, a connecting plug conforming to CF (Compact Flash Card) interface standard specification, a connecting plug conforming to Cfast (Compact Flash FAST Card) interface standard specification, a connecting plug conforming to MS (Memory Stick) interface standard specification, a connecting plug conforming to MMC (Multi Media Card) interface standard specification, a connecting plug conforming to SATA (Serial Advanced Technology Attachment) interface standard specification, a connecting plug conforming to IDE (Integrated Development Environment) interface standard specification, a connecting plug conforming to USB (Universal Serial Bus) interface standard specification, a connecting plug conforming to PCI-E (Personal Computer Interface Express), or other connecting plugs conforming to interface standard specifications used for transmitting data.

In another embodiment of the present invention, or otherwise, the signal transmitting connecting plug 37 may be also a signal transmitting connecting plug conforming to self-established specification, and may be also formed as a connecting plug in the form of PCB gold finger type interface or a connecting plug in the form of pin type interface, selectively.

The embedded memory module 300 is inserted into the signal transmitting connecting seat 53 of the main board 500 by means of the signal transmitting connecting plug 37, in such a way that the microprocessor 51 of the main board 500 is allowed to access the embedded memory module 300 with respect to at least one data conforming to eMMC (embedded Multi Media Card) transfer protocol specification through the inserted connection between the signal transmitting connecting plug 37 and connecting seat 53.

Here, the merits of the embedded memory module 300 of the present invention, coming from the provision of the controller 31 and flash memories 33 fabricated on the circuit board 35 instead of the package in the former ball grid array (BGA) form, may be obtained as follows:

(1). Easy inspection and maintenance with respect to the elements of the controller 31 and flash memories 33, further enhancing the yield rate of the embedded memory module 300 effectively, due to the fact that the controller 31, flash memories 33 and power supply circuit are installed on the circuit board 35 independently.

(2). Better effect of heat dissipation as well as easy replacement of one failed or damaged element may be achieved, due to the fact that the controller 31, flash memories 33 and power supply circuit are installed on the circuit board 35 independently.

(3). The embedded memory module 300 of the present embodiment is not packaged into a chip form so its size is no need for special regulation, in such a way that more flash memories 33 may be constructed so as to enhance the memory capacity of the embedded memory module 300.

(4). The embedded memory module 300 is inserted into a signal transmitting connecting seat 53 of the main board 500 by means of a signal transmitting connecting plug 37. Thus, a user is allowed to replace the embedded memory module 300 inserted into the main board 500 by himself, so as to enhance the convenience in memory repair or expansion.

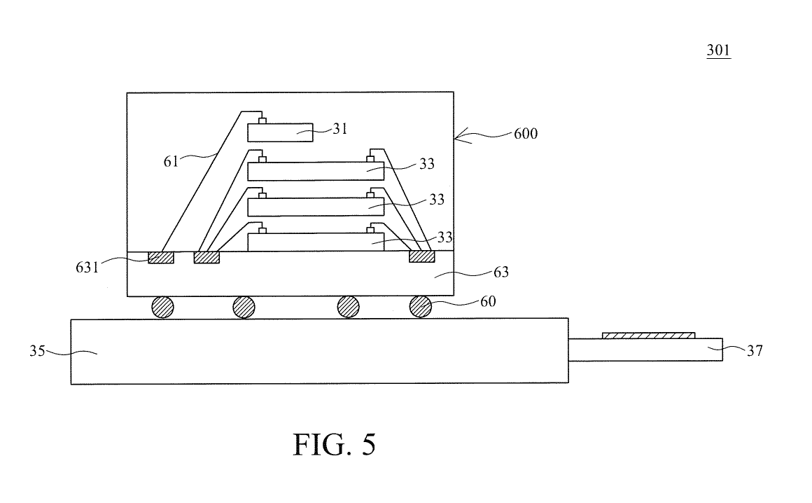

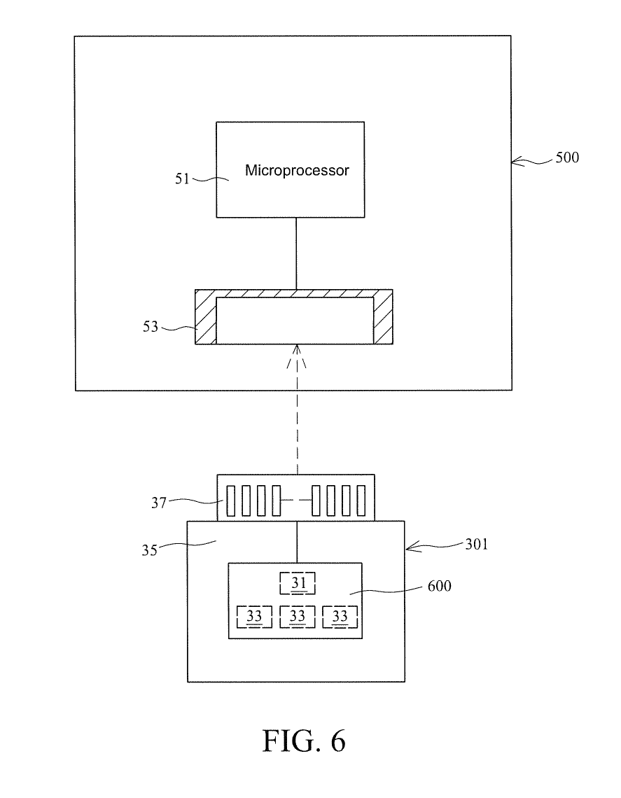

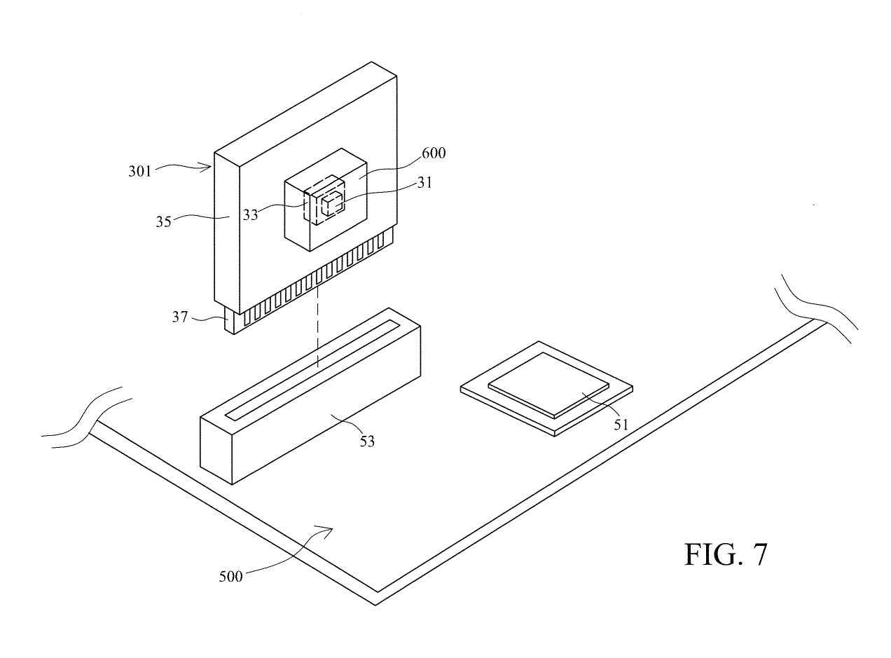

Referring to FIGS. 5, 6 and 7, there are shown a cross-section construction diagram of an embedded memory module according to one embodiment of the present invention, a circuit structure diagram and a stereoscopic construction diagram of the embedded memory module and a main board insertedly provided therefor according to one embodiment of the present invention, respectively. As illustrated in these figures, an embedded memory module 301 of the present embodiment is packaged in a way of BGA, such that the controller 31 and flash memories 33 are packaged in the structure of a chip 600.

The controller 31 and flash memories 33 packaged within the embedded memory chip 600 are stackingly provided on a substrate 63, below which a plurality of ball structures 60 (such as 169 ball structures, for example) are included. The controller 31 and the flash memories 33 are electrically connected to a lead frame 631 of the substrate 63 through leads 61, respectively. Moreover, the embedded memory chip 600 is joined to the circuit board 35 by means of the ball structures 60. Thus, the embedded memory module 301 of this embodiment may be fabricated.

Similarly, the embedded memory module 301 of the present embodiment is inserted into the signal transmitting connecting seat 53 of the main board 500 by means of the signal transmitting connecting plug 37, in such a way that the microprocessor 51 of the main board 500 is allowed to access the embedded memory module 301 with respect to at least one data conforming to eMMC transfer protocol specification.

As such, even if the embedded memory module 301 is fabricated in a way of BGA package, a user is also allowed to replace the embedded memory module 301 inserted into the signal transmitting connecting seat 53 of the main board 500 by himself, so as to enhance the convenience in memory repair or expansion.

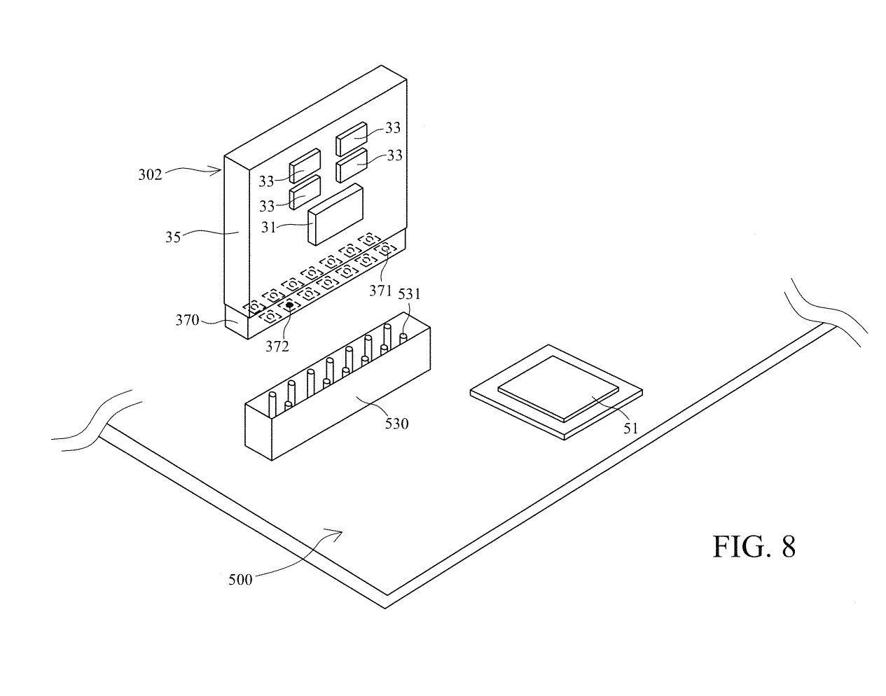

Referring to FIG. 8, there is shown a stereoscopic construction diagram of the embedded memory module and a main board insertedly provided therefor according to one embodiment of the present invention. As illustrated in this figure, the signal transmitting connecting plug 370 of the embedded memory module 302 and the signal transmitting connecting seat 530 of the main board 500 of the present embodiment may be formed as the form of pin type interface. The signal transmitting connecting plug 370 comprises a plurality of pin holes 371, and the signal transmitting connecting seat 530 comprises a plurality of pin headers 531. The signal transmitting connecting plug 370 may be connected to the pin headers 531 of the signal transmitting connecting seat 530 by means of the pin holes 371.

In present embodiment, the signal transmitting connecting plug 370 further comprises at least one foolproof hole 372, the position of the signal transmitting connecting seat 530 relative to the foolproof hole 372 of the signal transmitting connecting plug 370 doesn't set the pin header 531, in such a way that a foolproof effect will exist between the signal transmitting connecting plug 370 and the signal transmitting connecting seat 530.

In another embodiment of the present invention, the connection pins of the signal transmitting connecting plug 370 can be the pin headers, and the connection pins of the signal transmitting connecting seat 530 can be the pin holes. Of course, the signal transmitting connecting seat 530 can comprise the foolproof hole 372.

The foregoing description is merely one embodiment of the present invention and not considered as restrictive. All equivalent variations and modifications in shape, structure, feature, and spirit in accordance with the appended claims may be made without in any way from the scope of the invention.

1. An embedded memory module, comprising:
a circuit board, comprising a signal transmitting connecting plug;
at least one flash memory, used for storing data; and
a controller, said controller and said at least one flash memory being installed on said circuit board, said controller being connected to said at least one flash memory and said signal transmitting connecting plug, said embedded memory module transmitting at least one data conforming to eMMC (embedded Multi Media Card) transfer protocol specification by means of said signal transmitting connecting plug.

2. The embedded memory module according to claim 1, wherein said signal transmitting connecting plug is a connecting plug conforming to SD interface standard specification, a connecting plug conforming to CF interface standard specification, a connecting plug conforming to Cfast interface standard specification, a connecting plug conforming to MS interface standard specification, a connecting plug conforming to MMC interface standard specification, a connecting plug conforming to SATA interface standard specification, a connecting plug conforming to IDE interface standard specification, a connecting plug conforming to USB interface standard specification, a connecting plug conforming to PCI-E interface standard specification, other signal transmitting connecting plugs conforming to interface standard specifications used for transmitting data, a gold finger signal transmitting connecting plug conforming to self-established specification or a pin type signal transmitting connecting plug conforming to self-established specification.

3. The embedded memory module according to claim 1, wherein said signal transmitting connecting plug is formed as a gold finger interface connecting plug or a pin type interface connecting plug.

4. The embedded memory module according to claim 1, wherein said controller and said at least one flash memory are installed on said circuit board independently.

5. The embedded memory module according to claim 1, wherein said controller and said at least one flash memory are packaged as a ball grid array chip, so as to be joined to said circuit board by means of ball structures.

6. A main board, insertedly provided for the embedded memory module according to claim 1, comprising:
a microprocessor; and
at least one signal transmitting connecting seat, connected to said micro-processor;
wherein said embedded memory module is inserted into said connecting seat of said main board by means of said signal transmitting connecting plug, in such a way that said micro-processor of said main board is allowed to access said embedded memory module with respect to at least one data conforming to eMMC transfer protocol specification.

7. The main board according to claim 6, wherein said signal transmitting connecting plug comprises a plurality of pin holes and at least one foolproof hole, said signal transmitting connecting seat comprises a plurality of pin headers, and the position of said signal transmitting connecting seat relative to said foolproof hole of said signal transmitting connecting plug doesn't set said pin header.
